(19) United States
(12) Patent Application Publication
(10) Pub. No.: US 2016/0359330 A1
(43) Pub. Date: Dec. 8, 2016

(54) Systems and Methods for Dynamic Energy Distribution

(71) Applicant: Ruxiang Jin, Duluth, GA (US)

(72) Inventor: Ruxiang Jin, Duluth, GA (US)

(73) Assignee: Ruxiang Jin, Duluth, GA (US)

(21) Appl. No.: 15/154,579

(22) Filed: May 13, 2016

Related U.S. Application Data
(60) Provisional application No. 62/172,086, filed on Jun. 6, 2015.

(51) Int. Cl. H02J 3/38; H02J 50/30; H02J 7/35

(52) U.S. Cl. CPC H02J 3/383; H02J 7/35; H02J 50/30

(57) ABSTRACT

A dynamic network for energy-distribution can comprise energy converters, communication-and-control modules, power distribution switches, energy storage batteries, light emitters and light receivers located at spatially separated sites connected by optical transmission media, wherein each site can be equipped with energy transmitting, receiving or storage functionalities as well as signal-communication functionalities. The topology of the energy-distribution network can be changed dynamically by activating or deactivating optical links among the sites via software control. Charging vehicles can act as moving sites to remotely deliver energy to or receive energy from devices located at different sites of a network.

### CROSS-REFERENCE TO RELATED APPLICATIONS

This application claims the benefit of the date of provisional patent application No. 62/172,086 (Jun. 6, 2015).

### STATEMENT REGARDING FEDERALLY SPONSORED RESEARCH OR DEVELOPMENT (IF APPLICABLE)

The invention was NOT made by an agency of the United States Government or under a contract with an agency of the United States Government.

### REFERENCE TO SEQUENCE LISTING, A TABLE, OR A COMPUTER PROGRAM LISTING

Not applicable.

### COMPACT DISC APPENDIX (IF APPLICABLE)

Not applicable.

### BACKGROUND OF THE INVENTION

The present invention relates to systems and methods for allocating energy among a plurality of devices or equipment located at different sites. In particular, the present invention relates to methods and systems to dynamically distribute and store energy among a plurality of spatially separated sites in a communication- and energy distribution network.

The rapidly expanding Internet-of-Things (IOT) typically comprises an increasingly large number of sensors and communication devices driven mostly by electrical power. However in many cases it may be either inconvenient or undesirable to attach IOT devices to a conventional power grid. For example some IOT devices may be located in areas that are inaccessible to a power grid. Therefore in practice a large number of IOT devices are powered by their built-in rechargeable batteries. As the number of IOT devices located at different sites increase rapidly, locating, recharging, or replacing the batteries in IOT devices scattered in potentially diverse geographical locations is becoming a major challenge in terms of time consumption or material and labor cost.

Renewable energy sources including wind- and solar energy have been used in many distributive power generation applications, including off-grid electrical- and thermal power generation for buildings, farms, factories and various kinds of equipment. A majority of the prior-art solar systems use solar cells to convert solar energy to electrical energy for driving a variety of devices or equipment that use electricity as the primary power supply. Solar energy may also be converted to electrical energy indirectly by firstly converting solar energy to thermal energy, then using the thermal energy to drive a conventional generator to produce electricity. A high concentration photovoltaic system is capable of converting solar energy to electrical- and thermal energy simultaneously. The converted energy can be stored in batteries or insulated thermal materials to power electrical loads during low-sunlight time periods.

The predominant prior-art method of distributing renewable energy is to firstly convert the renewable energy to electrical energy, then feeding the electrical energy into an electrical power grid via controllers or inverters, and distribute the converted electrical energy to a plurality of spatially separated sites connected by a conventional wired power grid.

In conventional wired distribution systems, the sites connected by a power grid are mostly stationary, meaning that the spatial locations of the sites are fixed in most cases, and the number and the location of the sites cannot be changed easily in real time. For example, a solar power generation site may lose its ability to supply power to other sites of the wired grid if the weather conditions at the solar site are rainy or cloudy for an extended time period, or if the grid power is lost due to equipment malfunction or natural disaster. A backup battery located at the solar generation site can only partially alleviate the problem for a short time period (typically hours) because of high battery cost or high battery-power consumption rate.

In many applications it is preferable to deliver energy from one site to another through wireless means as it may be unsuitable to rely on conventional grid-tied energy delivery systems. For example, a site receiving wind-generated energy delivered from another site via a conventional power grid normally cannot be a fast moving vehicle or an airplane due to the difficulty of attaching electrical wires to these moving objects. Similarly, the distribution of solar-generated thermal energy to remote sites may pose a major challenge in terms of convenience and cost.

The advantages of the present invention will become more apparent with the detailed descriptions in the following sections. The specific details of the embodiments of the methods and systems described in the following sections are intended to serve as examples only, and are not intended to limit the scope of the invention.

### BRIEF SUMMARY OF THE INVENTION

The present invention provides methods and network systems for energy distribution and storage among a plurality of spatially separated sites. An example embodiment of said method comprises dynamically allocating photovoltaic energy to light emitters comprising optical gain media pumped by filtered sunlight power or photovoltaic power, allocating a certain amount of power to each emitter, and delivering light-beam energy from one site to a plurality of sites equipped with light power receivers having spectral responses matching the spectra of the emitters. The amount of energy allocated to each site can be determined by localized- or centralized computer control. A dynamic energy distribution network can be constructed by dynamically linking a plurality of sites through energy- and communication signal transceivers located at each site, and the status of each site can be adjusted via a computer-controlled signal communication network powered by said energy distribution network.

A renewable-energy distribution and storage system may comprise a wind or solar powered light beam generator to deliver energy from a power generation site to receivers located at spatially separated sites through an optical medium. The sites can either be spatially fixed or in relative motion to one another. Each site can include light beam receiving devices as well as communication devices for reciprocal energy distribution. A network including renewable-energy powered light beam transmitting- and receiving sites can be controlled by a software platform that dynamically redistributes solar energy among the sites.

The present invention also provides a communication network comprising network nodes or sites primarily powered by the dynamic energy distribution system of the present invention. The communication network node at each site comprises optical energy transceivers and communication-signal transceivers or amplifiers. A combination of energy- and communication signal receiving or transmitting functions can be assigned to each node, forming a network of nodes or sites among which energy can by dynamically distributed.

### BRIEF DESCRIPTION OF THE OF THE DRAWINGS

FIG. 1 depicts an example embodiment of the dynamic energy distribution system of the present invention.

FIG. 2 is a schematic representation of the reciprocal renewable energy delivery system of the present invention.

FIG. 3 depicts a dynamic energy distribution system using ground- and aerial vehicles to charge IOT devices.

FIG. 4 depicts an example embodiment for converting and distributing renewable energy to charge mobile devices.

FIG. 5 is an example embodiment of a dynamic energy-delivery network wherein the sites are equipped with various functionalities.

FIG. 6 is an example embodiment of a communication network powered by an energy distribution network of the present invention.

### DETAILED DESCRIPTION OF THE INVENTION

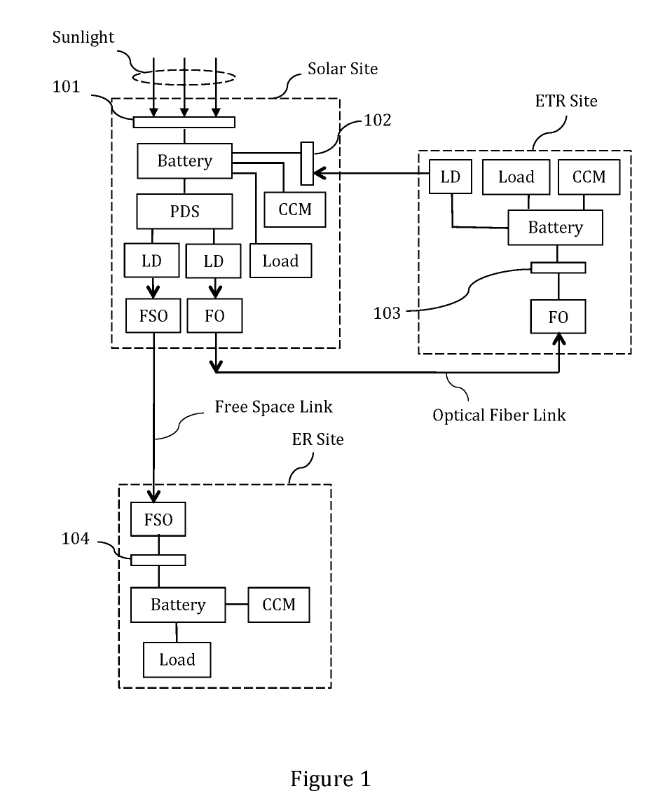

FIG. 1 shows, by way of example, an embodiment of the energy distribution system of the current invention. A solar site comprises a solar cell 101 that converts sunlight energy to electrical energy to charge a battery that supplies power to other devices and electrical loads at the site. The solar site battery can also be charged by receiving and converting optical power delivered from a spatially separate energy transmitting-receiving (ETR) site using a light-power receiver 102 that converts light energy to electrical energy. An optical fiber link and a free space link connect the solar site to the ETR site and to a separate energy-receiving (ER) site, respectively. Energy at the solar site is delivered to the ETR site by first coupling the light beam from a laser diode (LD) into an optical fiber using fiber optics (FO) components, and then transmitting the fiber-coupled light beam to the ETR site via an optical fiber link between the solar site and the ETR site. The FO components at the ETR site direct the received light beam onto a light-power receiver 103 that converts the received optical energy to electrical energy for charging a battery at the ETR site. Similarly, energy at the solar site can be delivered to the ER site by first forming a free-space light beam from a second LD using free space optics (FSO) components, and then transmitting the light beam to the ER site through free space or air. The FSO components at the ER site direct the received light beam onto a light power receiver 104 that converts optical energy to electrical energy for charging a battery at the ER site.

In FIG. 1, a power distribution switch (PDS) regulated by a communication-and-control module (CCM) determines the amount of energy allocated to each LD at the solar site. A common embodiment of the PDS may be a circuit that regulates the amount of electrical current supplied to each LD, thereby controlling the output power of the LDs as the output power of an LD generally increases with the driving current under its normal operating temperature range. An LD can be deactivated or switched off by cutting off the driving current or by reducing the driving current to be below the lasing-threshold current. The same is true for other light emitting devices that can be used for light-beam generation, including but not limited to light emitting diodes (LEDs), gas- and solid state lasers, super-luminescent light emitting diode (SLEDs), incandescent lamps and fluorescent lamps. The choice of light emitters depends on a plurality of factors including output power, optical medium, distance, spectrum and cost. The CCM is an onsite computer that can activate, deactivate or adjust the output power of each LD at any time using pre-programmed schedules or remotely controlled instructions.

The light power receivers 102, 103 and 104 that convert optical energy to electrical energy at each site can have different spectral response characteristics to accommodate potentially different light-beam spectra from different emitters at different sites. It is generally preferable to install a broadband light-power receiver so that light beams having a plurality of spectral characteristics from a variety of light emitters can be received. Semiconductor light-power receivers comprising silicon, germanium, gallium arsenide, aluminum gallium arsenide, indium gallium arsenide or a combination of these and other semiconductor- or other materials can be used to cover any wavelength in the ultraviolet- to infrared (IR) spectral range. For example, in the case of an optical fiber link it is preferable to use light emitters and light power receivers in the visible to near IR wavelength range (typically 400˜1800 nm) to reduce optical transmission loss.

Other forms of renewable energy generated at one site can likewise be distributed using the system of FIG. 1. For example, a solar cell 101 can be replaced by a wind-power generator so that wind power instead of solar power is converted to electrical power for charging the onsite battery. A hybrid renewable power generator comprising wind- and solar generators or any combination of conventional and renewable energy sources can also be used as onsite energy supply.

Thermal energy can also be delivered from one site to another in the system of FIG. 1 using preferably mid-IR LDs or far-IR lasers as emitters at energy-transmitting sites and thermal receivers that converts received light energy to thermal energy at energy-receiving sites. For long-range (many kilometers) thermal energy delivery via a free space link it may be preferable to use an IR laser emitter having a wavelength within the low-loss atmospheric spectral window.

The embodiment of the energy distribution systems and methods disclosed in all previous- and subsequent figures and sections are for example illustrations only, and are not intended for limiting the scope of general implementation of the present invention. For example, the PDS in FIG. 1 can be a variable optical beam splitter controlled by CCM for optically pumping the LDs or other light emitters. A conventional electrical grid may be used to supply power to a solar site during times when sunlight is insufficient to keep the onsite battery charged. The light-beam energy received at a site can be converted to electrical energy, thermal energy, or other forms of energy by appropriate energy receiving and converting devices such as photovoltaic converters or heat absorbing materials, and the resulting energy can be stored or directly utilized at the receiving site. Light beams may travel through multiple light transmission paths comprising diverse optical media with various refractive indexes and optical loss, such as optical fiber, light guide, air, liquid, or any sequential or parallel combination of various optical media. The CCM is a computer device with communication capabilities in a broad sense including any device with computing and communication capabilities represented in any form, such as central processor unit, microprocessor unit, desktop computer, notebook computer, cellular phone, laptop computer, pad device, programmable chip, system-on-chip, or any combination of computing and communication devices with related circuit boards and components. The communication among CCMs or between a CCM and another device can in general be continuous or intermittent at different time periods.

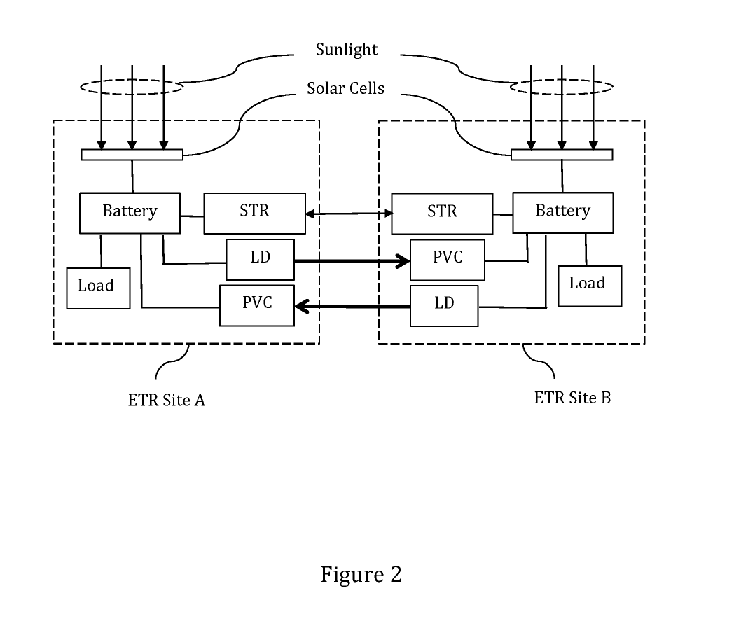

The present invention also provides a reciprocal energy delivery system comprising a local ETR site and a remote ETR site. In an example two-site system embodiment depicted in FIG. 2, wherein ETR Site A and ETR Site B are both solar sites, each site comprises solar cells, energy storage batteries, communications signal transceivers, LDs and photovoltaic cells (PVCs) for receiving and converting light-beam energy delivered by the other site. The vertical arrows in FIG. 2 represent the direction of sunlight, the thin horizontal arrows represent the direction of communication signal flow, and the thick horizontal arrows represent the direction of energy flow. An energy distribution network can be constructed by linking a plurality of ETR sites through various optical media, with each site equipped with various combinations of energy transmitting, receiving, storage, and communication functionalities.

The embodiment of FIG. 2 can make both ETR sites much more robust and dynamically adaptable to time varying onsite load-energy consumption rates and to changing external grid- or weather conditions. For example, in case the load energy consumption rate at an off-grid ETR Site A exceeds its battery charging rate during a time period that coincides with cloudy weather at the site, an energy-delivery request may be sent from ETR Site A to ETR Site B via the STR link, and the LD at ETR Site B can be activated to increase the charging rate of the battery at ETR Site A to satisfy its energy consumption requirement.

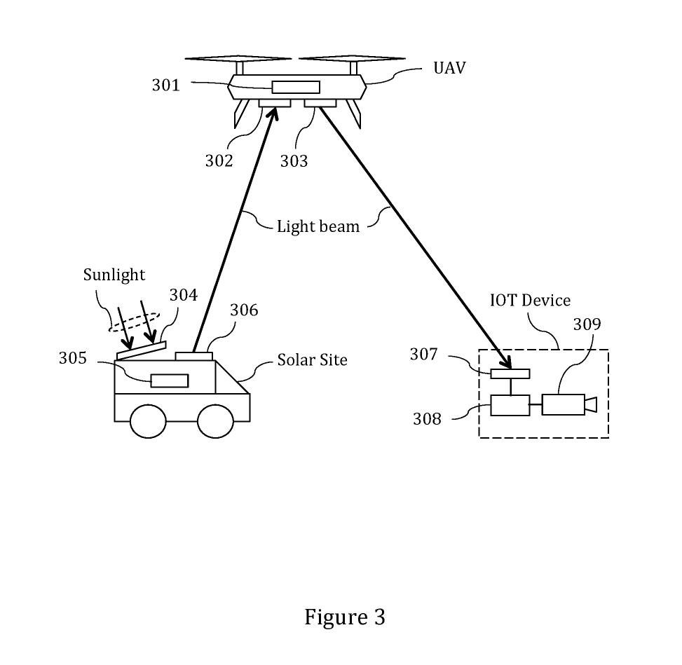

FIG. 3 is an example embodiment of the energy distribution system of the present invention wherein manned- or unmanned vehicles are employed to deliver energy to IOT devices located at separate sites, and when the sites are in relative motion with respect to one another. Depicted in FIG. 3 is a flying unmanned aerial vehicle (UAV) carrying a battery powered CCM 301 that is being charged by a light-power receiver 302 receiving light beam energy (represented by thick arrow) from a ground vehicle as the UAV delivers energy using a tracking light emitter 303 to an IOT device located at a site that may be unreachable by direct light beam from the ground vehicle. The ground vehicle can be equipped with solar cells 304 and with high-capacity battery powered CCM 305 so that the vehicle can be moved or positioned at an appropriate location to receive sunlight or to deliver energy to the UAV using a tracking light-beam transmitter 306 that tracks the real time position of the UAV for accurate beam pointing and efficient energy delivery to the UAV. Likewise the tracking light emitter 303 on the UAV is capable of accurately locating the position of the IOT device for accurate beam pointing and efficient energy delivery to the IOT device.

The IOT device depicted in FIG. 3 may comprise a light-power receiver 307 with a spectral response matching that of the light emitter 303, a battery powered CCM 308 and a sensor 309. The sensor can be a camera, a temperature sensor, a humidity sensor, a motion sensor, or other types of sensor, or a combination of a plurality of sensors.

Although only one IOT device in shown in FIG. 3, a plurality of IOT devices scattered at different locations can be charged time-sequentially or simultaneously by UAVs with a plurality of light emitters or beam splitting optics installed on the vehicles. Conversely, an IOT device can be charged time-sequentially or simultaneously by a plurality of UAVs and/or ground vehicles.

Some IOT devices can also be equipped with light-beam emitters to be energy transmitting-receiving IOT devices. The energy transmitting-receiving IOT devices are capable of charging other IOT devices or UAVs. One method of charging energy receiving IOT devices is to use a UAV to charge an energy transmitting-receiving IOT device in the vicinity of a plurality of energy receiving IOT devices, and to use the charged energy transmitting-receiving IOT device to further distribute energy among nearby energy receiving IOT devices.

A charging UAV can be equipped with a mirror or an optical component assembly to redirect or refocus a light beam that it receives from a ground vehicle or an energy-transmitting IOT device. For example, the light beam from the emitter 306 of the ground vehicle can be redirect by a reflecting mirror on the UAV to directly charge an IOT device without first converting light energy to electrical energy on the UAV, thereby avoiding energy-conversion loss in the charging process. Alternatively the light beam from the emitter 306 of the ground vehicle can be split into a plurality of light beams before being redirected by a UAV to charge a plurality of IOT devices at different locations simultaneously.

A charging UAV can be equipped with external energy collection and/or storage apparatus to increase its charging capacity. For example, the wings of a UAV can be covered with high efficiency solar cells to generate electricity for charging its battery. A pre-charged fuel cell battery may be installed on a UAV in conjunction with a regular rechargeable lithium battery to increase its energy storage capacity. Some charging UAVs may be equipped with only fuel cell batteries for charging other UAVs or IOT devices.

The spectral sensitivity range of light receivers 302, 304, 307 can be tailored to their corresponding light sources for maximized light-to-electricity energy conversion efficiency. For example, a high efficiency solar cell 304 can be used when the external energy source is sunlight. If the light source 306 is a single wavelength laser, then the receiver 302 can be designed to have a peak spectral response near the laser wavelength. Similarly, the spectral response of receiver 307 should match that of the emitter 303.

Although only one light emitter- and one corresponding receiver is used to illustrate the energy distribution method in the figures of the present invention, it should be understood that a plurality of emitters or receiver can be employed to enhance energy-delivery capabilities in an implementation of the present invention. For example, light from a plurality of emitters can be combined into one beam to generate a certain spectral profile to match the spectral response of a particular receiver. A plurality of receivers, each with a spectral response matching that of a particular emitter or a plurality of emitters, can also be used to enhance the power conversion capability at individual sites.

Centrally controlled communication links can be established among geographically scattered IOT devices equipped with battery powered CCMs 308. The batteries of IOT devices can be charged via periodic UAV charging missions. The charging UAV may receive a list of IOT devices to be charged during a charging mission with the list comprising Internet Protocol (IP)- and Media Access Control (MAC) address and the location information of each IOT device to be charged. As the UAV reaches the vicinity of an IOT device, they can establish communication using a wireless channel, and the UAV receives the MAC- and IP addresses together with the location- and authentication data from the IOT device. Then the CCM on the UAV authenticates the IOT device using customary device authentication techniques before sending a light beam to lock-in the IOT device and charging it. The lock-in process may include the UAV first sending a wide-angle pilot beam to cover the area wherein the IOT device is located, and then narrowing the beam angle while getting feedback from the IOT device on the light-power strength received by the light-power receiver 307 of the IOT device. Once maximum pilot-light reception strength is achieved an energy delivery light beam can be activated to delivery energy from the emitter 303 to the receiver 307. The pilot light can be from the same light emitter 303 with an adjustable focal length or from another emitter with adjustable focus, and the spectrum of the pilot light should be within the spectral sensitivity range of the light receiver 307. Other device-seeking, communication, authentication and tracking techniques can be used to locate IOT devices without departing from the method and the system of the present invention.

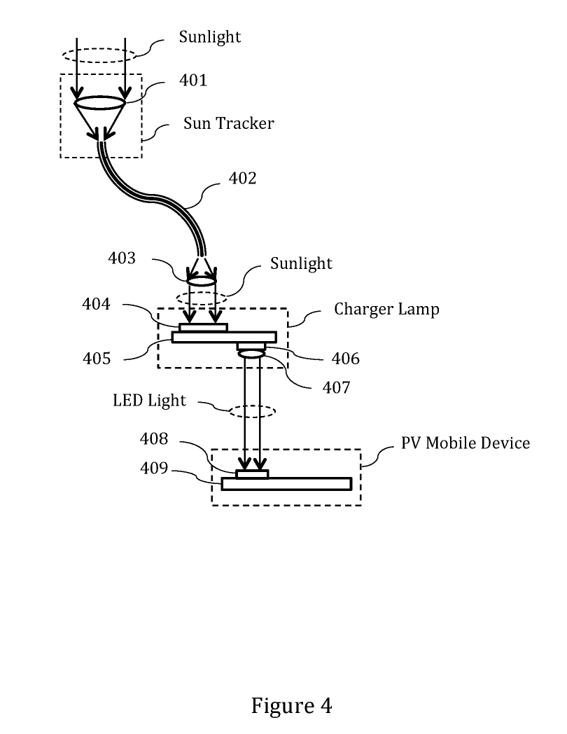

FIG. 4 is illustrates a method for charging IOT devices or mobile devices (such as cellular phones) using the energy delivery system of the present invention. A focusing lens 401 mounted on a sun tracker couples sunlight into an optical fiber 402, which delivers the coupled sunlight to another site comprising another lens 403 that spreads the sunlight exiting the optical fiber onto a solar cell 404 of a charger lamp. The sun tracker, which may be a smaller sized version of the dual-axis sun tracker commonly used in high concentration photovoltaic systems, ensures maximized sunlight collection by tracking and pointing the lens-fiber assembly toward the sun as the sun moves across the sky. The battery powered CCM 405 of the charger lamp sends a certain amount of power to a light emitter 406 whose emitted light profile is shaped by a lens 407, and is delivered onto a photovoltaic (PV) receiver 408 attached to a mobile device 409. A plurality of PV mobile devices can be charged simultaneously by installing multiple emitters 406 in the charger lamp or optically splitting or filtering the emitted light from an emitter 406 into multiple beams with their spectrum matching the spectral sensitivity range of the corresponding PV receivers 408.

Depending on practical considerations such as power, distance and cost, the light emitter 406 of FIG. 4 can be LD, LED, SLED, incandescent lamp, fluorescent lamp, any type of laser or light emitter, and the optical medium that brings sunlight to the charger lamp can be air, plastics or liquid light guide instead of optical fiber. The power supplied to the charger lamp can be from a conventional electrical grid instead of sunlight, or can be a combination of both. A device tracking mechanism such as described in previous sections can be incorporated into the charger lamp to enable automatic tracking and charging of a plurality of PV mobile devices.

The spectral sensitivity range of the light receiver 404 can be tailored to a particular light source for maximized light-to-electricity conversion efficiency. For example, a high efficiency solar cell can be used if the light source is sunlight. If the light source is a single wavelength laser, then the receiver may be designed to have a peak spectral response near the laser wavelength. Similarly, the spectral response of receiver 408 should match that of the emitter 406. Alternatively, light from a plurality of emitters may be combined to generate a certain spectral profile to match the spectral response of a particular receiver or a plurality of receivers, each with a spectral response matching that of a particular emitter, respectively.

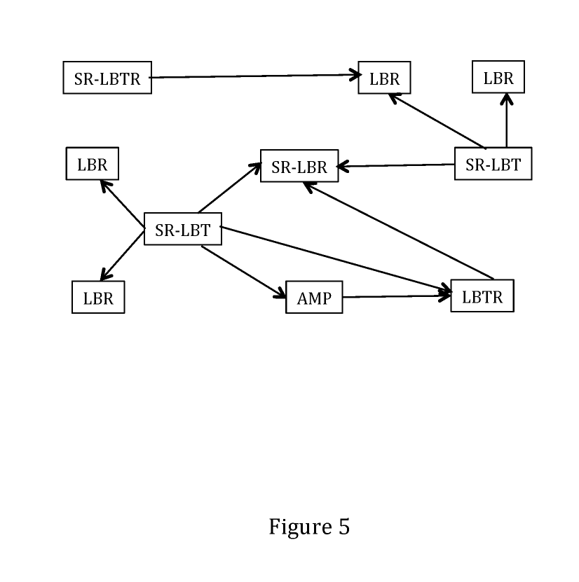

FIG. 5 is an example of the energy distribution network of the present invention comprising sites equipped with various functionalities. In the figure, SR represent sunlight receiving site, LBR represent light-beam receiving site, LBT represent light-beam transmitting site, LBTR represent light-beam transmitting-receiving site, and AMP represent light-energy amplification or boosting site. Some sites including SR-LBR, SR-LBT and SR-LBTR are equipped with both solar- and light-beam receiving and/or transmitting capabilities. A combination of energy receiving and transmitting functions can be assigned to each site, forming a network of sites among which solar energy can be dynamically distributed. The arrows in FIG. 5 represent the flow direction of light energy among the sites in the example energy-distribution network at a particular time.

As the sites in FIG. 5 are equipped with CCM, the topology of an energy-distribution network can be changed in real time by activating, deactivating, or redirecting the light beams from one site to other sites. As the FIG. 5 shows, a plurality of topologies can co-exist in a network at any given time, forming a generalized mesh network for energy distribution and signal communication.

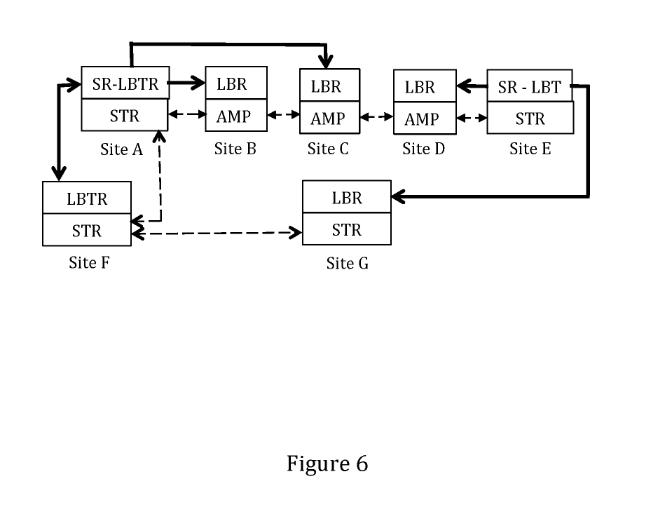

FIG. 6 shows, by way of example, a communication network of the present invention comprising network nodes located at Site A through Site G powered by the energy-distribution system of the present invention. The nodes of the communication network comprise energy transmitting/receiving apparatus (indicated by the top box at each site) as well as bidirectional signal-transceivers or signal amplifiers (indicated by the bottom box at each site). The top boxes in FIG. 6 represent the energy delivery functionalities of the sites, wherein SR represents sunlight receiving site, LBR represents light-beam receiving site, LBT represents light-beam transmitting site, and LBTR represents light-beam transmitting-receiving site. The bottom boxes represent communication-signal control capabilities of the network nodes, wherein STR represents bidirectional signal-transceiver site and AMP represents signal-amplifier site with STR functionality. The solid arrows in FIG. 6 represent the flow direction of light-beam energy, and the dashed arrows represent bidirectional communication links among the sites. In the example of FIG. 6, energy is directly distributed from Site A to Site B, Site C and Site F, and from Site E to Site D and Site G. Site A can also receive energy from Site F when needed. Each site in FIG. 6 is equipped with STR, and Site B, Site C, and Site D are also equipped with signal-amplification capability so that a direct signal communication link between Site A and Site E can be established via intermediate AMP sites even when the optical loss between Site A and Site E is too high to allow a direct signal link between the two sites.

FIG. 6 also illustrates that the topology of the energy-distribution network and the signal-communication network can be independent from each other. In general, a combination of energy- and communication-signal receiving and/or transmitting functionalities can be assigned to each site independently, forming a network of sites wherein energy can be dynamically distributed by using software control, and wherein the signal communication among the sites can also be dynamically established or abolished.

A variety of topologies in the energy-distribution network of FIG. 5 and FIG. 6 can be created in real time by using a software control platform that dynamically changes signal communication and beam delivery links among the network nodes. In an energy distribution network comprising a mixture of optical fiber and free space optical transmission media, the energy delivery link between any two nodes can be established or abolished by activating or deactivating the light beam connecting the nodes. An example network of star topology can be created by establishing direct energy delivery links from a central energy-transmitting site to a plurality of energy receiving sites via free space or optical fiber media. A network of ring topology can be created by linking a plurality of transmitting-receiving sites in succession. Optical amplification may be used at some sites to extend energy- or signal transmission range.

The solar sites in the example embodiment figures should only be regarded as a preference instead of a necessity in any potential embodiment of the present invention. For example, some or all of the sites in an energy-distribution network can be powered by a variety of external or internal energy sources such as fuel cell energy, wind energy, conventional grid energy, nuclear energy or other forms of energy, or a combination of a plurality of different energy sources.

The specific details of the embodiments of the methods and systems described in the preceding sections are intended to serve as examples only, and are not intended to limit the scope of the invention. A person with ordinary skills in the art will appreciate that slight alterations of the methods and systems described in the present invention will enable generation and dynamic distribution of thermal, electrical, light, sound, or other forms of energy, or any combinations of said energy, without departing from the spirit of the present invention.

1. A method for dynamically distributing energy among a plurality of spatially separated sites comprising:
converting electrical- or other forms of energy to light-beam energy by pumping an optical gain medium;
allocating different amount of power to a plurality of light-beam emitters via real-time or pre-programmed computer control;
transmitting light-beam energy from one site to at least one other site through at least one optical transmission medium;
creating dynamic energy distribution networks with arbitrary topology and with non-stationary inter-site positions by real-time position tracking and by linking a plurality of sites using a plurality of light beams;
adding or subtracting in real time the number of sites in a network and the amount of energy stored or consumed at each site of the network.

2. The method of claim 1, wherein manned- or unmanned vehicles or robots comprising light-beam generators and signal-communication devices function as additional sites of a network formed by connecting the sites of claim 1 for surveying network-site status and for dynamically delivering energy to targeted sites of said network.

3. The method of claim 2, wherein tracking and charging of a plurality of spatially separated devices by charging vehicles or robots comprise the steps of:
updating a controller computer in a charging vehicle with a list of devices to be visited or charged;
setting up a signal communication link between a device and a charging vehicle through an electromagnetic frequency channel;
verifying the digital address together with the location- and authentication information of a device;
using a pilot light and a signal feedback to track and locate a device for energy transmission or reception;
charging a device using a directional light beam once the device is authenticated and located.

4. The method of claim 3, wherein a charging vehicle installs, repairs, replaces, relocates or removes a device according to pre-determined routine or real time instructions from a control center, and updates the device status during the charging mission.

5. The method of claim 3, further comprising tracking and charging a plurality of devices located at different sites simultaneously by a charging vehicle.

6. An energy distribution system comprising:
at least one light-beam transmitting site and at least one light-beam receiving site linked by at least one optical transmission medium;
at least one light-power receiver for converting optical energy to electrical energy;
at least one battery to store electrical energy;
at least one light beam emitter;
at least one optical component assembly for controlling the transmitted or received light beams;
at least one onsite communication-and-control module.

7. The system of claim 6, wherein at least one site is equipped with a plurality of light emitters and a power distribution switch that dynamically allocates a certain amount of power to each emitter.

8. The system of claim 6, wherein a plurality of light-power receivers are installed at an energy receiving site to receive light-beam energy from a plurality of energy transmitting sites.

9. The system of claim 6, wherein at least one site is in spatial motion relative to other sites.

10. The system of claim 6, wherein at least two of the connected sites are reciprocal energy distribution and storage sites comprising:
at least two optical power transmitting and receiving sites connected by an optical transmission medium;
each of the two connected sites further comprising an energy storage battery, a light beam generator, an optical power converter, and a communication signal transceiver.

11. The system of claim 6, wherein a plurality of sites are arranged in a computer-controlled network configuration with each site capable of receiving light-beam energy from at least one other site of the network.

12. The system of claim 6, wherein an energy-distribution network comprises sites with various light transmitting- or receiving functionalities including:
external energy transmitting site;
external energy receiving site;
light beam transmitting site;
light beam receiving site;
external energy receiving and light beam transmitting site;
external energy receiving and light beam receiving site.

13. The energy distribution network of claim 12, wherein a software platform dynamically controls the real time establishment or abolishment of light-energy delivery links as well as signal-communication links among the sites of said network.

14. The energy-distribution network of claim 12, wherein at least one site is powered by a hybrid energy source comprising more than one form of energy.

15. The network of claim 12, further comprising a communication network powered by the energy distribution system of claim 6.

16. A wireless charging system comprising:
an optical charger further comprising:
a storage battery;
a light emitter;
a control-and-communication module;
a light-energy receiver attached to a device to be charged;
at least one optical transmission medium linking the optical charger and the device to be charged.

17. The system of claim 16, wherein the optical charger further comprising a photovoltaic receiver for converting sunlight- or light-beam energy to electrical energy to pump at least one light emitter of the charger.

18. The system of claim 16, wherein the light emitter of the optical charger is pumped by filtered sunlight power, grid power, battery power, or a combination of a plurality of different power sources.

19. The system of claim 16, wherein the optical charger further comprising a location tracker to locate the device to be charged.

20. The system of claim 16, wherein the optical charger comprising a plurality of light beams with pre-defined spectral characteristics to simultaneously charge a plurality of devices located at different sites.
